(19) United States
(12) Patent Application Publication
(10) Pub. No.: US 2010/0142498 A1
(43) Pub. Date: Jun. 10, 2010

(54) METHOD OF PERFORMING RADIO LINK MEASUREMENT IN WIRELESS COMMUNICATION SYSTEM

(76) Inventor: Koo Hyounhee, Gyeongki-do (KR)

Correspondence Address: MCKENNA LONG & ALDRIDGE LLP, 1900 K STREET, NW, WASHINGTON, DC, 20006, US

(21) Appl. No.: 12/733,067

(22) PCT Filed: Aug. 7, 2008
(86) PCT No.: PCT/KR2008/004584

§ 371 Date: Feb. 5, 2010

Related U.S. Application Data
(60) Provisional application No. 60/956,927, filed on Aug. 21, 2007.

(30) Foreign Application Priority Data
Aug. 7, 2007 (KR) 10-2007-0079107
Oct. 25, 2007 (KR) 10-2007-0107518

(51) Int. Cl. H04W 36/00; H04B 7/212

(52) U.S. Cl. 370/337; 455/435.2

(57) ABSTRACT

A method of performing a radio link measurement includes receiving a measurement control message from a serving cell, the measurement control message comprising priority information which comprises at least one of priorities of radio access technologies (RATs), selecting at least one cell of the RATs based on the priority information, and performing a measurement on a signal received from the selected cell over a measurement period, the measurement period comprising a plurality of multi-frames, a multi-frame comprising a plurality of time division multiple access (TDMA) frames and at least one search frame, a TDMA frame comprising a plurality of time slots, wherein the measurement on the selected cell is performed during the at least one search frame.

### TECHNICAL FIELD

The present invention relates to wireless communications, and more particularly, to interoperability between a global system for mobile communication (GSM)/general packet radio service (GPRS) system and a radio access technology (RAT).

### BACKGROUND ART

The Global System for Mobile communication (GSM) is a radio technology which has been developed as a system for standardizing radio communication systems in Europe and which has widely been deployed all over the world. The General Packet Radio Service (GPRS) is introduced to provide a packet switched data service in a circuit switched data service provided from the GSM. The Enhanced Data Rate for GSM Evolution (EDGE) employs the 8-PSK (Phase Shift Keying) instead of the GMSK (Gaussian Minimum Shift Keying) employed in the GSM. The Enhanced General Packet Radio Service (EGPRS) represents the GPRS using the EDGE.

A physical channel dedicated to GPRS/EGPRS traffic is called Packet Data Channel (PDCH). Logical channels such as Packet Common Control Channel (PCCCH), Packet Data Traffic Channel (PDTCH) and Packet Associated Control Channel (PACCH) are mapped to the PDCH. The PCCCH is used for control signaling necessary for initiating packet transfer. The PDTCH is used to transmit user data. The PACCH is used for dedicated signaling.

GSM/GPRS system is based on time division multiple access (TDMA). Information bits (or bursts) are transmitted when communication is made between a base station (BS) and a mobile station (MS), and are delivered to the BS or the MS according to a timeslot. Hereinafter, downlink is defined as a communication link from the BS to the MS, and uplink is defined as a communication link from the MS to the BS.

The GSM/GPRS system based on the TDMA can be referred to as a 2nd generation (2G) wireless communication system, whereas a universal mobile telecommunication system (UMTS) based on a wideband code division multiple access (WCDMA) according to the third generation partnership project (3GPP) can be referred to as a 3rd generation (3G) wireless communication system. A UMTS Terrestrial Radio Access Network (UTRAN) is a collective term for the BSs and Radio Network Controllers (RNCs) which make up the UMTS radio access network. Further description of UMTS may be found in ‘WCDMA in UMTS’, Harri Holma, Antti Toskala, Wiley & Sons, 2001, ISBN 0471486876. Standardization on a long term evolution (LTE) wireless communication system based on an orthogonal frequency division multiple access (OFDMA) is also in progress in the 3GPP. The LTE system is also referred to as an evolved-UMTS (E-UMTS). An Evolved-UTRAN (E-UTRAN) is a term for BSs based on the LTE system. Further description of LTE may be found in 3GPP TS 36.300 V8.0.0 (2007-03) ‘Technical Specification Group Radio Access Network; Evolved Universal Terrestrial Radio Access (E-UTRA) and Evolved Universal Terrestrial Radio Access Network (E-UTRAN); Overall description; Stage 2 (Release 8)’.

GSM EDGE Radio Access Network (GERAN) is referred to a radio access technology (RAT) of GSM/EDGE together with the network that joins the base stations and the base station controllers. Hereinafter, a reference RAT is the GERAN, and a different RAT is a RAT which is not the GERAN. For example, the different RAT may be the UTRAN or the E-UTRAN.

With the introduction of various types of wireless communication system, interoperability between the existing GERAN and a new RAT (UTRAN/E-UTRAN) has arisen as a problem. The introduction of the new RAT compatible with the existing GERAN results in convenience from the perspective of users and also results in the reuse of the existing equipment from the perspective of service provides.

The UTRAN supports a compressed mode to measure neighboring cells of a network using a different frequency, which may be found in the clause 4.4 of 3GPP TS 25.212 V7.1.0 (2006-06) ‘Multiplexing and channel coding (FDD) (Release 7)’. The compressed mode denotes temporary suspension of transmission and reception to perform measurements on different frequencies.

In preparation for a handover from the GERAN to the different RAT, the MS needs to perform measurements on the neighboring cells. This is referred to as inter-RAT cell reselection. In the GERAN, the measurements are performed during a specific frame called a search frame, which can be found in the clause 8 of 3GPP TS 45.008 V7.6.0 (2006-11) ‘Radio Access Network; Radio subsystem link control (Release 7)’. When in an idle mode or a packet idle mode, the MS can monitor cells belonging to the different RAT without problems. However, when the MS is in dedicated mode, packet transfer mode or dual transfer mode (DTM), there may be some problems to perform measurements for all the different RATs since only limited measurement gaps for the MS. The MS in dedicated mode, packet transfer mode or DTM may not be provided search frames enough to measure all the different RATs. There are also limitations regarding the number of neighboring cells that the MS can include in the measurement reports.

It is difficult for the GERAN based on the TDMA to allocate a measurement gap enough to measure cells of all the different RATs. This is because radio resources can be wasted if the allocated measurement gap is significantly large. On the contrary, if the allocated measurement gap is significantly small, the neighboring cells may not be able to be detected.

### DISCLOSURE OF INVENTION

### Technical Problem

The present invention provides a method of measuring a signal from a different radio access technology (RAT) by a mobile station (MS) receiving a service in a global system for mobile communication (GSM)/general packet radio service (GPRS) system.

### Technical Solution

In an aspect, a method of enabling a mobile station (MS) to perform a radio link measurement in a wireless communication system is provided. The method includes receiving a measurement control message from a serving cell, the measurement control message comprising priority information which comprises at least one of priorities of radio access technologies (RATs), selecting at least one cell of the RATs based on the priority information, and performing a measurement on a signal received from the selected cell over a measurement period, the measurement period comprising a plurality of multi-frames, a multi-frame comprising a plurality of time division multiple access (TDMA) frames and at least one search frame, a TDMA frame comprising a plurality of time slots, wherein the measurement on the selected cell is performed during the at least one search frame.

In another aspect, a method of performing a radio link measurement in a wireless communication system is provided. The method includes receiving priority information which comprises a priority of a different RAT, and performing a measurement on a signal received from a cell of the different RAT over a measurement period when the cell of the different RAT is selected based on the priority information, the measurement period comprising a plurality of multi-frames, a multi-frame comprising a plurality of time division multiple access (TDMA) frames and at least one search frame, a TDMA frame comprising a plurality of time slots, wherein the measurement on the cell is performed during the at least one search frame.

### Advantageous Effects

When a mobile station (MS) is in dedicated mode, cells of a different radio access technology (RAT) can be effectively measured while minimizing an influence of a voice service in use. In addition, when the MS is in packet transfer mode, if a different RAT cell that can support a fast packet data service exists around the MS, packet service with the higher rate can be provided by promptly performing a handover. By allowing proper use of a network, resources of service providers can be effectively used, and improved voice services and packet services can be provided to users.

### BRIEF DESCRIPTION OF THE DRAWINGS

FIG. 1 is a block diagram showing a wireless communication system.

FIG. 2 shows a structure of a multi-frame used for measurement in a dedicated mode.

FIG. 3 shows a structure of a multi-frame used for measurement in a packet transfer mode.

FIG. 4 is a flow diagram showing a measurement method according to an embodiment of the present invention.

FIG. 5 shows an example of various time configurations for a measurement period when a global system for mobile communication (GSM)/general packet radio service (GPRS) coexists with a different radio access technology (RAT).

FIG. 6 shows an example of a time configuration when a mobile station (MS) is in a dedicated mode.

FIG. 7 shows another example of a time configuration when an MS is in a dedicated mode.

FIG. 8 shows an example of a time configuration when an MS is in a packet transfer mode according to an embodiment of the present invention.

FIG. 9 shows an example of a structure of a multi-frame when a type D is used in a packet transfer mode.

FIG. 10 shows an example of a time configuration when an MS is in a packet transfer mode according to another embodiment of the present invention.

### MODE FOR THE INVENTION

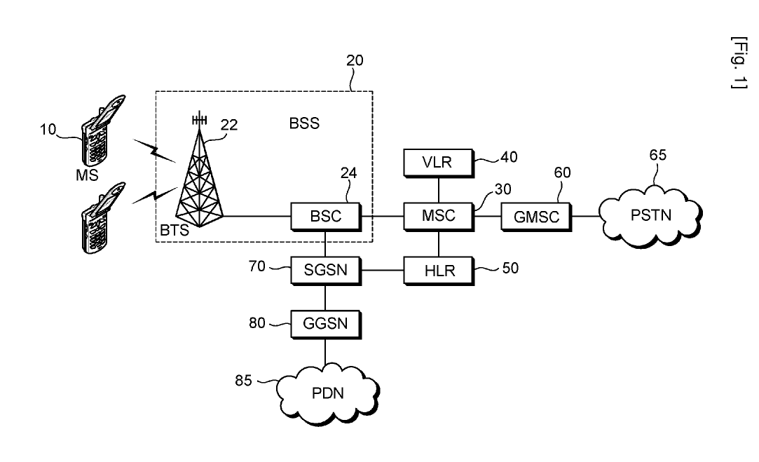

FIG. 1 is a block diagram showing a wireless communication system. The wireless communication system has a network structure based on a global system for mobile communication (GSM)/general packet radio service (GPRS) system. The GPRS to be described hereinafter can include not only a general GPRS but also an enhanced GPRS (EGPRS). The wireless communication system can be widely deployed to provide a variety of communication services, such as voices, packet data, etc.

Referring to FIG. 1, a mobile station (MS) 10 denotes a communication device carried by a user, and may be referred to as another terminology, such as a user equipment (UE), a user terminal (UT), a subscriber station (SS), a wireless device, etc.

A base station subsystem (BSS) 20 includes a base transceiver station (BTS) 22 and a base station controller (BSC) 24. The BTS 22 communicates with the MS 10 located in one cell area through a radio interface, and performs synchronization or the like with the MS 10. The BSC 24 interfaces a mobile switching center (MSC) 30 to at least one BTS 22.

The MSC 30 connects the BSS 20 to a heterogeneous network such as a public switching telephone network (PSTN) 65, a public land mobile network (PLMN), etc., through a gateway MSC (GMSC) 60. A visitor location register (VLR) 40 stores temporary user data and includes roaming information of all MSs 10 in a service area of the MSC 30. A home location register (HLR) 50 includes information on all subscribers of a home network. A serving GPRS support node (SGSN) 70 provides mobility management of subscribers. A gateway GPRS support node (GGSN) 80 routes a packet to a current location of the MS 10 and provides an interface to an external packet data network such as a public data network (PDN) 85.

A temporary block flow (TBF) is a logical connection offered by two Medium Access Control (MAC) entities so as to support the unidirectional transfer of Radio Link Control (RLC) Protocol Data Unit (PDU) on basic physical subchannels. The TBF is not provided in a packet idle mode. In the packet idle mode, any radio resource on a packet data physical channel is not assigned to the MS. At least one TBF is provided in a packet transfer mode. In the packet transfer mode, radio resources on one or more packet data physical channels for the transfer of packet data are assigned to the MS. The MAC-idle state means a MAC-control-entity state where no basic physical subchannel is assigned. A Temporary Flow Identity (TFI) is assigned to each TBF by the network. The MS assumes that the TFI value is unique among concurrent TBFs in the same direction (uplink or downlink) on all Packet Data Channels (PDCHs) used for the TBFs. The same TFI value may be used concurrently for TBFs on other PDCHs in the same direction and for TBFs in the opposite direction.

The MS receives a circuit-switched service in the dedicated mode. The MS receives a packet-switched service in the packet transfer mode. A GSM-based service is provided in the dedicated mode. A GPRS (or EGPRS)-based service is provided in the packet transfer mode. When in a dual transfer mode (DTM), the MS is both in the dedicated mode and the packet transfer mode.

The GSM/GPRS system based on the TDMA can be referred to as a 2nd generation (2G) wireless communication system, whereas a universal mobile telecommunication system (UMTS) based on a wideband code division multiple access (WCDMA) according to the third generation partnership project (3GPP) can be referred to as a 3rd generation (3G) wireless communication system. A UMTS Terrestrial Radio Access Network (UTRAN) is a collective term for the BSs and Radio Network Controllers (RNCs) which make up the UMTS radio access network. Further description of UMTS may be found in ‘WCDMA in UMTS’, Harri Holma, Antti Toskala, Wiley & Sons, 2001, ISBN 0471486876. Standardization on a long term evolution (LTE) wireless communication system based on an orthogonal frequency division multiple access (OFDMA) is also in progress in the 3GPP. The LTE system is also referred to as an evolved-UMTS (E-UMTS). An Evolved-UTRAN (E-UTRAN) is a term for BSs based on the LTE system. Further description of LTE may be found in 3GPP TS 36.300 V8.0.0 (2007-03) ‘Technical Specification Group Radio Access Network; Evolved Universal Terrestrial Radio Access (E-UTRA) and Evolved Universal Terrestrial Radio Access Network (E-UTRAN); Overall description; Stage 2 (Release 8)’.

GSM EDGE Radio Access Network (GERAN) is referred to a radio access technology (RAT) of GSM/EDGE network, UMTS Terrestrial Radio Access Network (UTRAN) is referred to a RAT of the UMTS radio access network, and evolved-UTRAN (E-UTRAN) is referred to as a RAT of LTE network. Hereinafter, a reference RAT is the GERAN, and a different RAT is a RAT which is not the GERAN. For example, the different RAT may be the at least one of the UTRAN and the E-UTRAN.

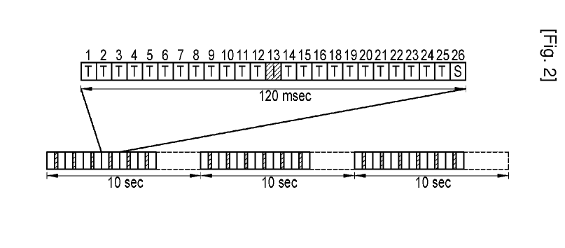

FIG. 2 shows a structure of a multi-frame used for measurement in the dedicated mode. This is a case where all neighboring cells are GERAN cells, that is, a measurement is not performed on a different RAT cell.

Referring to FIG. 2, a multi-frame includes 26 time division multiple access (TDMA) frames in dedicated mode. One TDMA frame includes at least one time slot. The 26 TDMA frames include 24 TDMA frames T, each of which includes a burst of a traffic channel, one TDMA frame S reserved for a slow associated control channel (SACCH), and one idle frame I. During the idle frame I, the MS does not perform transmission and reception but performs measurements on the neighboring cells. The idle frame I is also referred to as a search frame. Herein, a 13th TDMA frame among the 26 TDMA frames is used as the idle frame I. However, locations and the number of frames are shown for exemplary purposes only. For example, the idle frame may be located in a 26th TDMA frame, and the SACCH may be located in the 13th TDMA frame.

In the dedicated mode, a measurement period is 10 seconds. That is, the MS has to attempt to acquire synchronization with the neighboring cells in every measurement period (i.e., 10 sec) as much as possible, as frequently as possible, and at least once. For the 10 seconds, such a synchronization acquisition operation is performed during the idle frame in the multi-frame structure.

FIG. 3 shows a structure of a multi-frame used for measurement in the packet transfer mode. This is a case where all neighboring cells are GERAN cells.

Referring to FIG. 3, a multi-frame includes 52 TDMA frames in packet transfer mode. Among the 52 TDMA frames, a 26th TDMA frame and a 52th TDMA frame are used as idle frames I, also referred to as search frames.

In comparison with the multi-frame in the dedicated mode, the search frames occur once in every 120 msec in both the packet transfer mode and the dedicated mode. Thus, the number of search frames for performing measurements on the neighboring cells is identical in both of the two cases during the same measurement period (e.g., 10 sec). The MS has to attempt to acquire synchronization with the neighboring cells in every measurement period (i.e., 10 sec) as much as possible and as frequently as possible. A difference between the dedicated mode and the packet transfer mode lies in that a synchronization acquisition operation has to be attempted at least once for cells included in a neighbor cell list in the dedicated mode whereas such a requirement does not exist in the packet transfer mode. For 10 seconds, the measurements are performed during the search frame included in the multi-frame.

In the following descriptions, the neighboring cells may include not only the GERAN cells but also cells of a different RATs. The different RAT denotes a network system employing frequencies and/or radio access technologies different from those of the GERAN. For example, the RAT may be a UTRAN, a E-UTRAN, a RAT of an institute of electrical and electronics engineers (IEEE) 802.16-based system, etc. It is assumed that the MS is a multi-RAT MS supporting not only the GERAN but also the different RAT. When an MS having a GERAN cell as a serving cell measures a different RAT cell, this is called an inter-RAT measurement.

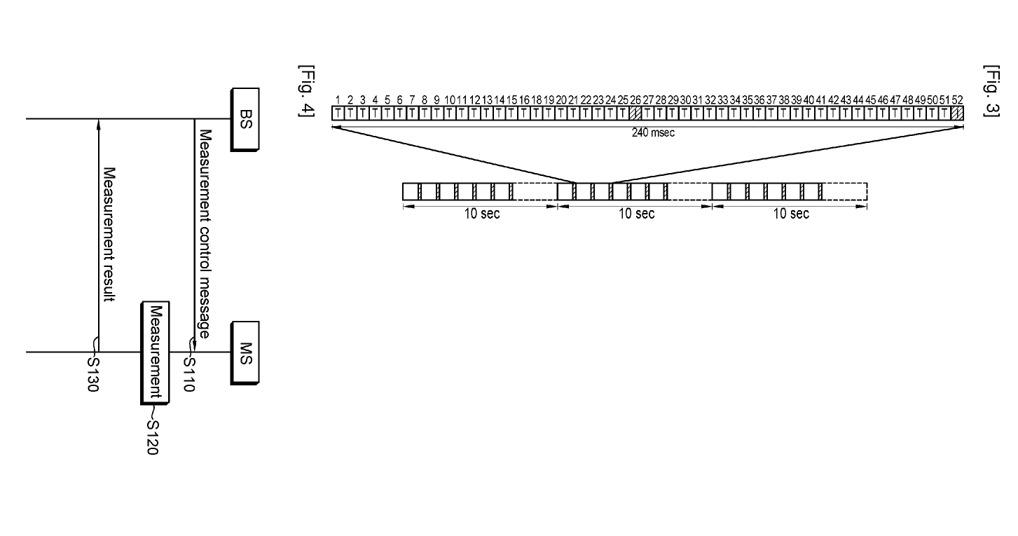

FIG. 4 is a flow diagram showing a measurement method according to an embodiment of the present invention.

Referring to FIG. 4, in step S110, an MS receives a measurement control message from a base station (BS) (i.e., a serving cell). The measurement control message includes information required when the MS performs measurements on neighboring cells. The measurement control message may be broadcast as system information or may be delivered by the BS only to the MS. The measurement control message includes information on a measurement period for performing measurements. In addition, the measurement control message includes priority information for measuring a different RAT. The priority information may be provided in an RAT unit or in a cell unit of the RAT.

In step S120, the MS selects an RAT cell to be measured according to the priority information, and performs a measurement on the selected cell over the measurement period. The MS performs the measurement only on the RAT selected according to the priority instead of performing measurements on all RAT cells listed in a neighbor cell list. Therefore, all required RAT cells can be measured while maintaining a measurement period approximately similar to the conventional one.

In step S130, the MS reports a measurement result to the BS. The MS may perform a cell reselection according to the priority information.

Now, priority information and various measurement periods for performing measurements on cells of a different RAT will be described.

The priority information is used to select at least one cells of the RATs to be measured or to perform cell reselection. The priority information may be provided by a serving cell or may be pre-configured in an MS. For clarity, the priory information is described in the unit of a RAT, hereinafter, but the priory information may have in the unit of a RAT cell.

The priority information can be represented as various formats such as the absolute priority of a respective RAT, the relative priority with reference to a reference RAT, a ratio of priories of two RATs, etc.

In an embodiment, the priority information may include priorities between at least two RATs. For example, if the value of the priority information is ‘0’, it means that the E-UTAN has higher priority than the UTRAN. If the value of the priority information is ‘1’, it means that the UTRAN has higher priority than the E-UTRAN. Alternatively, if the value of the priority information is ‘00’, it means that priorites of RATs are in order of E-UTRAN, GERAN and UTRAN. If the value of the priority information is ‘01’, it means that priorites of RATs are in order of GERAN, UTRAN and E-UTRAN. If the value of the priority information is ‘10’, it means that priorites of RATs are in order of E-UTRAN, UTRAN and GERAN. If the value of the priority information is ‘11’, it means that priorites of RATs are in order of GERAN, E-UTRAN and UTRAN.

In another embodiment, the priority information may include priorities of different RATs with reference to the GERAN. For example, if the value of the priority information is ‘0’, it means that the E-UTAN has higher priority than the GERAN and the UTRAN has lower priority than the GERAN. If the value of the priority information is ‘1’, it means that the UTRAN has higher priority than the GERAN and the E-UTRAN has lower priority than the GERAN.

FIG. 5 shows an example of various time configurations for a measurement period when a GERAN coexists with the different RAT. This is a case where a maximum of 2 types of different RATs coexist in addition to a GERAN cell. The time configurations for the measurement period are divided into 7 categories, that is, a type A to a type G.

Referring to FIG. 5, in the type A, two different RAT cells (i.e., a first RAT cell and a second RAT cell) exist in addition to a GERAN cell. A measurement period of the GERAN cell is fixed to 10 sec. A measurement period of the first RAT cell (e.g., a UTRAN cell) is fixed to 3 sec. A measurement period of the second RAT cell (e.g., an E-UTRAN cell) is set to T0. The value T0 may be a fixed value or may be transmitted by a network.

In the type B, a measurement period of a GERAN cell is fixed to 10 sec. A measurement period of a first RAT cell is set to T0. A measurement period of a second RAT cell is set to T1. The values T0 and T1 may be fixed values or may be transmitted by the network.

In the type C, even when a plurality of different RAT cells exist in addition to a GERAN cell, the network specifies a particular RAT cell and informs the specified RAT cell to the MS. A measurement period of the GERAN cell is fixed to 10 sec. A measurement period of the specified different RAT cell is set to T0. The value T0 may be a fixed value or may be transmitted by a network.

In the type D, a measurement period of a GERAN cell is set to T0. A measurement period of a first RAT cell (e.g., a UMTS cell) is set to T1. A measurement period of a second RAT cell is set to T2. The values T0, T1, and T2 may be fixed values or may be transmitted by the network.

In the type E, even when a plurality of different RAT cells exist, the network specifies a particular RAT cell and informs the specified RAT to the MS. A measurement period of the GERAN cell is set to T0. A measurement period of the specified different RAT cell is set to T1. The values T0 and T1 may be fixed values or may be transmitted by the network.

In the type F, one different RAT cell exists in addition to a GERAN cell. A measurement period of the GERAN cell is fixed to 10 sec. A measurement period of the different RAT cell is set to T0. The value T0 may be a fixed value or may be transmitted by a network.

In the type G, one different RAT cell exists in addition to a GERAN cell. A measurement period of the GERAN cell is set to T0. A measurement period of the different RAT cell is set to T1. The values T0 and T1 may be fixed values or may be transmitted by the network.

The aforementioned fixed values, i.e., 10 sec or 3 sec, are provided for exemplary purposes only. In addition, although the time configurations described above are based on two different networks, the number of different networks is not limited thereto. Thus, the technical features of the present invention may also be applied when 3 or more different networks are used.

Although it is described herein that the measurement period of the GERAN cell is separated from that of the different RAT cell, the measurement period may be a continuous time period. Alternatively, the measurement period may denote a total time period required to search for different RAT cells during the entire measurement period. For example, considering a multi-frame having one search frame and having a length of 120 msec, if a measurement period is 13 sec (i.e., a measurement period of the GERAN cell is 10 sec and a measurement period of the first RAT cell is 3 sec), the MS can use up to 25 search frames to perform a measurement on the first RAT cell in every 13 sec.

When the MS is currently located in a place where the different RAT cells coexist with the GERAN cell, the MS can effectively perform measurements on the neighboring cells by using limited resources. In addition, priorities may be assigned to various types of different RATs (e.g., UTRAN and E-UTRAN) so that measurements can be performed on the neighboring cells while minimizing an influence on the existing GSM/GPRS system.

Now, a time configuration for each measurement period will be described for a case where an MS is in the dedicated mode and a case where the MS is in the packet transfer mode.

When the MS is in the dedicated mode, voice services are provided in general. During a voice call is made, a handover to a different RAT occurs less frequently than a handover to a GERAN cell. Therefore, when the MS is in the dedicated mode, it is preferable that neighboring GSM cells are measured with priority. This is because the voice service has a top priority. Under this assumption, when in the dedicated mode, the MS considers the use of the types A, B, C, and F, in which the measurement period of the GERAN cell is fixed to 10 sec, among the time configurations defined in FIG. 5.

In the following descriptions, measurement period information for adjusting synchronization with a neighboring cell may be transmitted by using a measurement information message or a system information type 2-quarter message. The measurement information message is a downlink message transmitted through an SACCH. The measurement information message includes measurement-related parameters. Further descriptions of the measurement information message may be found in the clause 9.1.54 of 3GPP TS 44.018 V7.9.0 (2007-06) ‘Mobile radio interface layer 3 specification; Radio Resource Control (RRC) protocol (Release 7)’. The system information type 2-quarter message is a downlink message transmitted through a broadcast control channel (BCCH). The system information type 2-quarter message includes additional information regarding measurements on the neighboring cells. Further description of the system information type 2-quarter message may be found in the clause 9.1.34a of 3GPP TS 44.018 V7.9.0 (2007-06) ‘Mobile radio interface layer 3 specification; Radio Resource Control (RRC) protocol (Release 7)’.

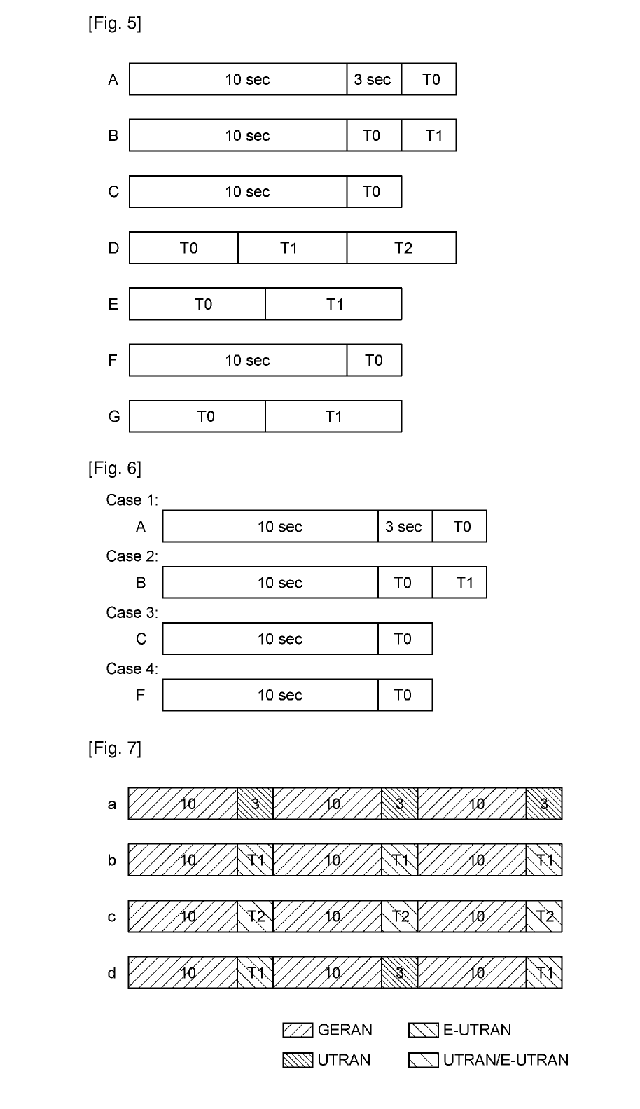

FIG. 6 shows an example of a time configuration when an MS is in the dedicated mode.

Referring to FIG. 6, a type A shows a case where two different RAT cells (i.e., a first RAT cell and a second RAT cell) exist in addition to a GERAN cell. A measurement period of the GERAN cell is fixed to 10 sec. A measurement period of the first RAT cell (e.g., a UTRAN cell) is fixed to 3 sec. A measurement period of the second RAT cell (e.g., an E-UTRAN cell) is set to T0. The value T0 may be transmitted by using a measurement information message or a system information type 2-quarter message. When the value T0 is determined to a fixed value, information required for synchronization of the different RAT cells may be transmitted by using the measurement information message or the system information type 2-quarter message. The measurement period of the GERAN cell is fixed to 10 sec, so that a handover is performed while not deteriorating quality of a voice service of the MS in the dedicated mode.

In a type B, a measurement period of a GSM/GPRS is fixed to 10 sec. A measurement period of a first RAT cell is set to T0. A measurement period of a second RAT cell is set to T1. The values T0 and T1 may be transmitted by using the measurement information message or the system information type 2-quarter message. The measurement period of the GERAN cell is set to the same as the previous case. Measurement periods of the different RAT cell are variable.

In a type C, even when a plurality of different RAT cells exist, a network determines priority of the plurality of different RAT cells. A measurement is performed only on a different RAT cell having priority. For example, in a case where a UTRAN cell and an E-UTRAN cell exist as neighboring cells, if the network assigns a highest priority to the E-UTRAN cell, the MS performs a measurement on the E-UTRAN cell with a measurement period of T0 irrespective of a measurement result of a serving cell. If the UTRAN cell has an equal or lower priority than the serving cell, the measurement is performed according to the measurement result of the serving cell. That is, if the measurement result of the serving cell is below a threshold, the measurement is performed on the UTRAN cell. The MS receives priority information from the network. The priority information includes priorities of at least one RATs (or RAT cell). The priority information or the T0 value may be transmitted by using the measurement control message or the system information type 2-quarter message. Alternatively, even if priority is assigned to a first RAT cell, the first RAT cell may use a fixed measurement period, and the T0 value may be used as a measurement period of a second RAT cell.

In a type F, one different network exists. A measurement period of a GERAN cell is fixed to 10 sec. A measurement period of the different RAT cell is set to T0. The T0 value may be transmitted by using the measurement information message or the system information type 2-quarter message.

The aforementioned types may be fixedly used by the MS. Alternatively, the BS may select one of the types A to F, and delivers the selected type to the MS so that different types are used for acquiring synchronization with neighboring cells.

FIG. 7 shows another example of a time configuration when an MS is in the dedicated mode.

Referring to FIG. 7, four types (i.e., a, b, c, and d) are shown for acquiring synchronization with different RAT cells (i.e., a UTRAN cell and an E-UTRAN cell) when the MS is in the dedicated mode in a GERAN cell. A value T1 or a value T2 may be a fixed value or may be reported to the MS by using a message.

In general, to avoid quality deterioration of a voice service, service providers operating a GSM/GPRS system prefers a handover to a different network during the voice service is provided in the dedicated mode over a handover to the different network after the voice service is finished. Considering the limited number of search frames for searching for the GERAN cell, the BS can inform the MS a specific type to be used. For example, when the MS searches for the GERAN cells and the UTRAN cells in the type a, the MS can switch to the type b for searching for the E-UTRAN cells. When returning to an idle mode, the MS can move to a different RAT cell found in the dedicated mode.

Now, a method of performing an inter-RAT measurement by an MS in the packet transfer mode will be described.

Packet transmission may be more effective when using a UMTS system or an LTE system than when using a GSM/GPRS system. Therefore, when UTRAN cells or E-UTRAN cells exist around the MS, a handover is performed to that cell and thereafter a packet service is supported. Accordingly, a further improved service is provided. It is necessary to perform a handover promptly to a different RAT such as the UTRAN or the E-UTRAN.

Measurement period information is provided to measure neighboring cells in the packet transfer mode and may be transmitted by using a packet measurement information message, a packet cell change order message, or a packet system information type 3-quarter message.

In the packet transfer mode, measurement periods (e.g., the types A, B, C, and F of FIG. 5) fixed for the GERAN cell can be also used by the MS. In this case, a message for providing information regarding the neighboring cells may be a packet measurement order message, a packet cell change order message, or a packet system information type 3-quarter message. Further description of the packet measurement order message may be found in the clause 11.2.9b of 3GPP TS 44.060 V7.7.0 (2006-12) ‘Mobile Station (MS)—Base Station System (BSS) interface; Radio Link Control/Medium Access Control (RLC/MAC) protocol (Release 7)’. Further description of the packet cell change order message may be found in the clause 11.2.4 of 3GPP TS 44.060 V7.7.0 (2006-12) ‘Mobile Station (MS)—Base Station System (BSS) interface; Radio Link Control/Medium Access Control (RLC/MAC) protocol (Release 7)’. Further description of the packet system information type 3-quarter message may be found in the clause 11.2.21b of ‘3GPP TS 44.060 V7.7.0 (2006-12) Mobile Station (MS)—Base Station System (BSS) interface; Radio Link Control/Medium Access Control (RLC/MAC) protocol (Release 7)’.

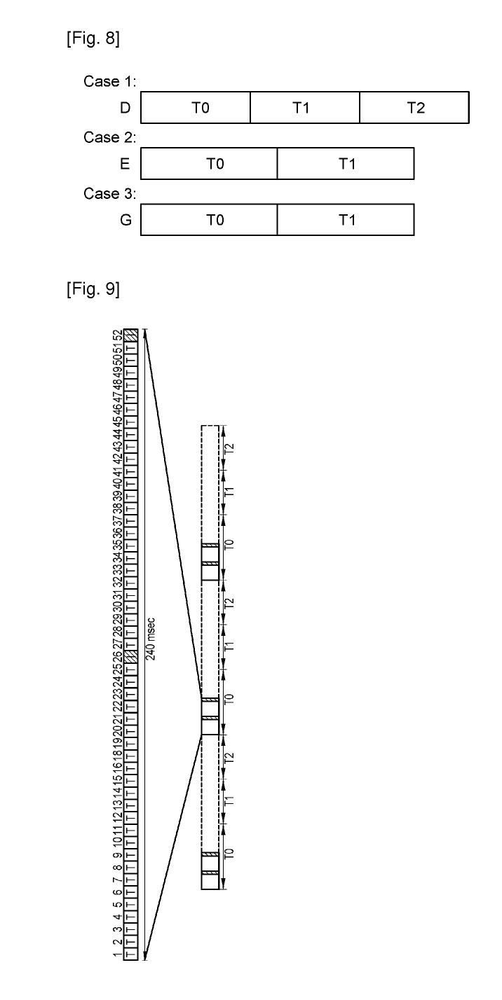

FIG. 8 shows an example of a time configuration when an MS is in the packet transfer mode according to an embodiment of the present invention.

Referring to FIG. 8, in the packet transfer mode, a measurement period of a GERAN cell can be assigned variably instead of being assigned to a fixed value. Under this assumption, in the packet transfer mode, the MS can further consider the use of the types D, E, and G among the time configurations defined in FIG. 5.

In the type D, a measurement period of the GERAN cell is set to T0, a measurement period of a first RAT (e.g., a UTRAN cell) is set to T1, and a measurement period of a second RAT cell (e.g., an E-UTRAN cell) is set to T2. The values T0, T1, and T2 may be fixed values or may be delivered from a network to the MS by using a packet measurement order message, a packet cell change order message, or a packet system information type 3-quarter message. The network determines the values T0, T1, and T2 by considering a network configuration environment where the MS is current located and then transmits the determined values.

In the type E, even when a plurality of different RAT cells exist, the network determines priority of the plurality of different RAT cells. A measurement is performed only on a different RAT cell having priority. For example, in a case where a UTRAN cell and an E-UTRAN cell exist as neighboring cells, if the network assigns a top priority to the E-UTRAN cell, the MS performs a measurement on the GERAN cell with a measurement period of T0 and performs a measurement on the E-UTRAN cell with a measurement period of T1 irrespective of a measurement result of a serving cell. If the UTRAN cell has an equal or lower priority than the serving cell, the measurement is performed according to the measurement result of the serving cell. That is, if the measurement result of the serving cell is below a threshold, the measurement is performed on the UTRAN cell. The MS receives priority information from the network. The priority information indicates which RAT (or RAT cell) has priority among neighboring RATs. The priority information or the values T0 and T1 may be transmitted by using the packet measurement order message, the packet cell change order message, or the packet system information type 3-quarter message.

In the type G, one different RAT cell exists in addition to a GERAN cell. A measurement period of the GERAN cell is set to T0. A measurement period of the different RAT cell is set to T1. The values T0 and T1 may be fixed value or may be transmitted by using the packet measurement order message, the packet cell change order message, or the packet system information type 3-quarter message.

The aforementioned types may be fixedly used by the MS. Alternatively, the BS may select one of the types D, E, and G, and delivers the selected type to the MS so that different types are used for acquiring synchronization with neighboring cells.

FIG. 9 shows an example of a structure of a multi-frame when the type D is used in the packet transfer mode.

Referring to FIG. 9, the multi-frame includes 52 TDMA frames in the packet transfer mode. Among the 52 TDMA frames, a 26th TDMA frame and a 52th TDMA frame are idle frames I.

A measurement period of a GERAN cell is set to T0, a measurement period of a first RAT (e.g., a UTRAN cell) is set to T1, and a measurement period of a second RAT cell (e.g., an E-UTRAN cell) is set to T2. The values T0, T1, and T2 may be fixed values or may be delivered from a network to the MS by using a packet measurement order message, a packet cell change order message, or a packet system information type 3-quarter message. The network determines the values T0, T1, and T2 by considering a network configuration environment where the MS is current located and then transmits the determined values.

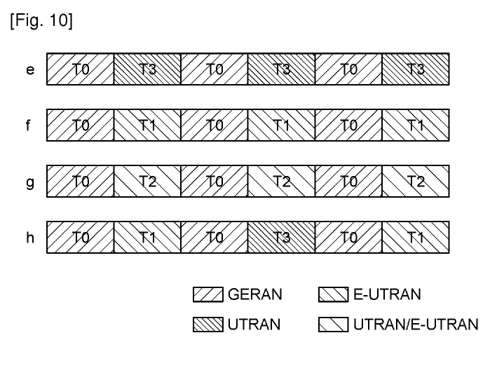

FIG. 10 shows an example of a time configuration when an MS is in the packet transfer mode according to another embodiment of the present invention.

Referring to FIG. 10, four types (i.e., e, f, g, and h) are shown for acquiring synchronization with different RAT cells (i.e., a UMTS cell and an LTE cell) when the MS is in the packet transfer mode in a GERAN cell. Values T0 to T3 may be fixed values or may be reported to the MS by using a message.

If a service provider enables the MS to perform a handover to a different network after finishing a packet service, the MS operating in the packet transfer mode can perform a measurement with the same time configuration as the embodiment of FIG. 7. For an improved packet service, measurement periods T1 and T2 for searching for different networks are determined to be longer than those in the packet transfer mode.

The BS can change a measurement period of the MS, for example, from the type e to the type f according to priority of neighboring RATs around the MS and a purpose of a measurement on a different RAT.

When the MS is in the dedicated mode, cells of the different RAT can be effectively measured while minimizing an influence of an available voice service. In addition, when the MS is in the packet transfer mode, if the different RAT that can support a fast packet data service exists around the MS, the packet service can be received faster by promptly performing a handover. By allowing proper use of a network, resources of service providers can be effectively used, and improved voice services and packet services can be provided to users.

The steps of a method described in connection with the embodiments disclosed herein may be implemented by hardware, software or a combination thereof. The hardware may be implemented by an application specific integrated circuit (ASIC) that is designed to perform the above function, a digital signal processing (DSP), a programmable logic device (PLD), a field programmable gate array (FPGA), a processor, a controller, a microprocessor, the other electronic unit, or a combination thereof. A module for performing the above function may implement the software. The software may be stored in a memory unit and executed by a processor. The memory unit or the processor may employ a variety of means that is well known to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

1. A method of enabling a mobile station (MS) to perform a radio link measurement in a wireless communication system, the method comprising:
receiving a measurement control message from a serving cell, the measurement control message comprising priority information which comprises at least one of priorities of radio access technologies (RATs);
selecting at least one cell of the RATs based on the priority information; and
performing a measurement on a signal received from the selected cell over a measurement period, the measurement period comprising a plurality of multi-frames, a multi-frame comprising a plurality of time division multiple access (TDMA) frames and at least one search frame, a TDMA frame comprising a plurality of time slots, wherein the measurement on the selected cell is performed during the at least one search frame.

2. The method of claim 1, wherein the serving cell is a cell of GSM EDGE Radio Access Network (GERAN).

3. The method of claim 1, wherein the RATs are at least one of UMTS Terrestrial Radio Access Network (UTRAN) and Evolved-UTRAN (E-UTRAN).

4. The method of claim 1, wherein the priorities of RATs are set with reference to a priority of GERAN.

5. The method of claim 1, wherein a cell of the RAT is selected when the cell of the RAT has higher priority than the serving cell.

6. The method of claim 1, further comprising:
performing a measurement on a signal received from the serving cell, wherein a cell of the other RAT is selected when the cell of the other RAT has equal or lower priority than the serving cell, and the measurement result of the serving cell is below a threshold.

7. The method of claim 1, wherein the measurement period is 13 seconds.

8. The method of claim 7, wherein up to 25 search frames are used to perform the measurements during the measurement period.

9. The method of claim 7, wherein the measurement is performed in one of dedicated mode, packet transfer mode and dual transfer mode.

10. A method of performing a radio link measurement in a wireless communication system, the method comprising:
receiving priority information which comprises a priority of a different RAT; and
performing a measurement on a signal received from a cell of the different RAT over a measurement period when the cell of the different RAT is selected based on the priority information, the measurement period comprising a plurality of multi-frames, a multi-frame comprising a plurality of time division multiple access (TDMA) frames and at least one search frame, a TDMA frame comprising a plurality of time slots, wherein the measurement on the cell is performed during the at least one search frame.

11. The method of claim 10, wherein the measurement on the different RAT is performed in one of dedicated mode, packet transfer mode and dual transfer mode.

12. The method of claim 10, wherein the cell of the different RAT is selected when the cell of the different RAT has higher priority than the serving cell.

13. The method of claim 10, further comprising:
performing a measurement on a signal received from the serving cell, wherein the cell of the different RAT is selected when the cell of the different RAT has equal or lower priority than the serving cell, and the measurement result of the serving cell is below a threshold.
